(19) United States
(12) Patent Application Publication
(10) Pub. No.: US 2022/0032745 A1
(43) Pub. Date: Feb. 3, 2022

(54) VEHICLE

(71) Applicant: TOYOTA JIDOSHA KABUSHIKI KAISHA, Toyota-shi (JP)

(72) Inventors: Masaru TOYOTA, Toyota-shi (JP); Sho TSUMITA, Seto-shi (JP); Yoshiyuki RYUNO, Nagoya-shi (JP)

(73) Assignee: TOYOTA JIDOSHA KABUSHIKI KAISHA, Toyota-shi (JP)

(21) Appl. No.: 17/340,505

(22) Filed: Jun. 7, 2021

(30) Foreign Application Priority Data
Jul. 31, 2020 (JP) 2020-131016

(51) Int. Cl. B60J 1/17; B60J 5/04

(52) U.S. Cl. CPC B60J 1/17; B60J 10/79; B60J 5/0402

(57) ABSTRACT

A vehicle includes: a vehicle body; a side door provided openably and closably in the vehicle body, the side door including at least a first window opening and a second window opening; first window glass provided in a fixed manner in the first window opening of the side door; and second window glass configured to be manually raised and lowered, the second window glass being provided in the second window opening of the side door. The first window opening is placed ahead of the second window opening in the vehicle front-rear direction, and the first window opening has an area larger than an area of the second window opening.

### CROSS-REFERENCE TO RELATED APPLICATION

This application claims priority to Japanese Patent Application No. 2020-131016 filed on Jul. 31, 2020, incorporated herein by reference in its entirety.

### BACKGROUND

### 1. Technical Field

The technology described in the present specification relates to a vehicle.

### 2. Description of Related Art

Japanese Unexamined Patent Application Publication No. 2001-323737 (JP 2001-323737 A) describes a side door for a vehicle. The side door includes two window openings. The window opening on the front side is provided with window glass provided in a fixed manner, and the window opening on the rear side is provided with window glass configured to be raised and lowered. The window glass configured to be raised and lowered is opened and closed by a raising-lowering device. The raising-lowering device is placed inside the side door and moves the window glass in the up-down direction in response to the operation of a motor. Note that, as the raising-lowering device for window glass, a raising-lowering device which does not include a power source such as a motor and which moves window glass in the up-down direction in response to a user operation on a handle or the like has been also known.

### SUMMARY

In vehicles in the related art, window glass provided in a door is opened and closed by a raising-lowering device. In this respect, it is conceivable that window glass configured to be manually raised and lowered may be employed for vehicles such as ultra-lightweight vehicles, for example. The window glass configured to be manually raised and lowered indicates window glass that is operated in the up-down direction directly by a user without the use of a raising-lowering device. The use of the window glass configured to be manually raised and lowered makes it unnecessary to use the raising-lowering device, thereby making it possible to reduce the weight of a vehicle, for example.

It is necessary that the window glass configured to be manually raised and lowered have a relatively small size so that the window glass configured to be manually raised and lowered can be operated effortlessly by force of a user. However, a reduction in the size of the window glass leads to a reduction in the size of the window opening. The window opening of the side door also functions as an escape route for the user in an emergency. Therefore, when the size of the window opening is reduced, the function as the escape route might be impaired.

In consideration of the above problem, the present specification provides a technology that can secure an escape route for a user in an emergency and improve operationality for the user in a vehicle that employs window glass configured to be manually raised and lowered.

A vehicle described in the present specification includes a vehicle body, a side door, first window glass, and second window glass. The side door is provided openably and closably in the vehicle body, and the side door includes at least a first window opening and a second window opening. The first window glass is provided in a fixed manner in the first window opening of the side door. The second window glass is configured to be manually raised and lowered, and the second window glass is provided in the second window opening of the side door. The first window opening is placed ahead of the second window opening in the vehicle front-rear direction. The first window opening has an area larger than an area of the second window opening. Note that, as described above, the window glass configured to be manually raised and lowered indicates window glass that is operated in the up-down direction directly by a user without the use of a mechanism such as a raising-lowering device, for example.

In the above vehicle, the side door includes the first window opening and the second window opening, and the first window opening has an area larger than that of the second window opening. With such a configuration, when the first window opening having a relatively large area is set as an escape route for the user in an emergency, the area of the second window opening can be made small without any restriction. Hereby, the size of the second window glass to be provided in the second window opening, that is, the size of the window glass configured to be manually raised and lowered can be made small, so that the operationality for the user can be improved. Further, the first window opening is placed ahead of the second window opening in the vehicle front-rear direction and is placed generally diagonally forward of the user. In such a positional relationship, the user can easily break the window glass in an emergency, so that the first window opening is easily usable as the escape route.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a side view schematically illustrating a whole vehicle 10 and mainly illustrates a right side face of the vehicle 10;

FIG. 2 is a view illustrating a side door 20 viewed from the inside of the vehicle 10 (that is, from a vehicle cabin side) together with an internal structure of the side door 20, and second window glass 32 is placed at an upper limit position;

FIG. 3 is a view illustrating the side door 20 viewed from the inside of the vehicle 10 (that is, from the vehicle cabin side) together with the internal structure of the side door 20, and the second window glass 32 is placed at a lower limit position; and

FIG. 4 is a view illustrating the magnitude relationship between a first window opening 28a where first window glass 30 is broken and a dummy doll DM from the same viewpoint as FIGS. 2, 3.

### DETAILED DESCRIPTION OF EMBODIMENTS

In one aspect of this technology, the first window opening may have a size and a shape that allow a dummy doll as an adult male model to pass through the first window opening. With such a configuration, the first window opening can have a sufficient size and a sufficient shape as an escape route for many users having standard figures. The dummy doll used herein indicates a dummy doll for vehicle collision test.

This type of dummy doll may be “WorldSID 50th” defined in the international standard ISO15830 by the International Organization for Standardization or “Hybrid-III 50th” defined in federal regulations “49 CFR Part 572 Subparts E and 0” of the National Highway Traffic Safety Administration (NHTSA) of the United States of America. The first window opening may have a size and a shape that allow at least either of these two types of dummy dolls to pass through the first window opening, although the first window opening is not limited in particular.

In one aspect of this technology, the first window opening may be placed most forward in the vehicle front-rear direction among the window openings provided in the side door. With such a configuration, when the first window opening is placed diagonally forward of a user, the user can easily break the first window glass in an emergency. That is, the first window opening is easily usable as the escape route. In addition, even at the time of normal driving, the user can easily visually recognize a diagonally front side from the vehicle through the relatively large first window opening.

In one aspect of this technology, the second window glass may not include a frame on a peripheral edge of the second window glass. With such a configuration, the second window glass is further reduced in weight, so that operationality for the user can be improved.

In one aspect of this technology, a knob to be gripped by a user may be provided in the second window glass. With such a configuration, the user can easily operate the second window glass by use of the knob. However, the knob is not necessarily required, and as another aspect, a recessed portion on which the user puts his or her finger may be directly provided in the second window glass, for example.

In the above aspect, the knob may include a movable hook to be operated by the user. In this case, the side door may include a hook receiver configured to lock the second window glass by engaging with the hook when the second window glass closes the second window opening. With such a configuration, the second window glass that closes the second window opening can be locked so that the second window glass does not move down unintentionally.

In one aspect of this technology, the side door may further include a third window opening placed rearward of the second window opening in the vehicle front-rear direction and including third window glass provided in a fixed manner. With such a configuration, by adjusting the size and the shape of the third window opening as well as the size and the shape of the first window opening, the size and the shape of the second window opening can be designed freely regardless of the shape of the side door. Hereby, the size and the shape of window glass to be provided in the second window opening, that is, the size and the shape of the second window glass configured to be manually raised and lowered can be designed freely, thereby making it possible to effectively improve the operationality for the user.

In the above aspect, the third window opening may have an area smaller than the area of the second window opening. When the third window opening is made small in a limited size of the side door, the first window opening can be made large by just that much. This can improve the function of the first window opening as the escape route.

With reference to the drawings, a vehicle 10 of an embodiment will be described. The vehicle 10 of the present embodiment is a so-called automobile and is a vehicle traveling on a road surface. Here, a direction FR in the drawings indicates the front side in the front-rear direction (the longitudinal direction) of the vehicle 10, and a direction RR indicates the rear side in the front-rear direction of the vehicle 10. Further, a direction LH indicates the left side in the right-left direction (the width direction) of the vehicle 10, and a direction RH indicates the right side in the right-left direction of the vehicle 10. A direction UP indicates the upper side in the up-down direction (the height direction) of the vehicle 10, and a direction DN indicates the lower side in the up-down direction of the vehicle 10. Note that, in the present specification, the front-rear direction, the right-left direction, and the up-down direction of the vehicle 10 may be just referred to as the front-rear direction, the right-left direction, and the up-down direction.

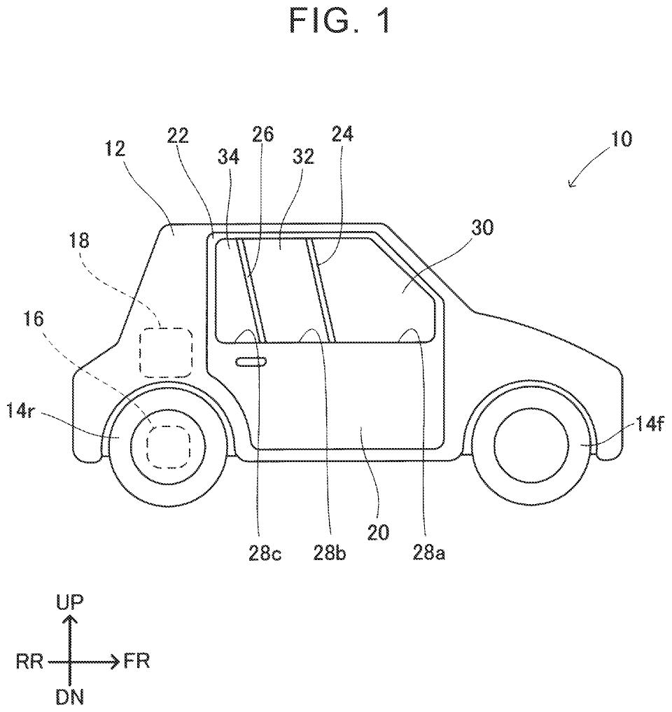

As illustrated in FIG. 1, the vehicle 10 includes a vehicle body 12 and a plurality of wheels 14f, 14r. The vehicle body 12 is not limited in particular, but the vehicle body 12 is formed by use of a metallic material and a resin material. The wheels 14f, 14r are rotatably attached to the vehicle body 12. The wheels 14f, 14r include a pair of front wheels 14f and a pair of rear wheels 14r. Note that the number of the wheels 14f, 14r is not limited to four. The vehicle 10 in the present embodiment has a small size for one occupant, but the size of the vehicle 10 and the number of occupants are also not limited in particular.

The vehicle 10 further includes a drive motor 16 and a battery unit 18. The drive motor 16 is connected to the rear wheels 14r, so that the drive motor 16 can drive the rear wheels 14r. Note that the drive motor 16 is not limited to driving the rear wheels 14r, provided that the drive motor 16 is configured to drive at least one of the wheels 14f, 14r. The battery unit 18 is connected to the drive motor 16 via a power supply circuit (not shown), so that the battery unit 18 supplies electric power to the drive motor 16. A plurality of secondary battery cells is incorporated in the battery unit 18, so that the battery unit 18 is chargeable repeatedly by electric power received from outside. Note that the vehicle 10 may include other power supplies such as a fuel cell unit or a solar panel in addition to or instead of the battery unit 18. Further, the vehicle 10 may include other motors such as an engine in addition to or instead of the drive motor 16.

The vehicle 10 further includes a side door 20. The side door 20 is placed on a right side surface of the vehicle body 12 and is provided openably and closably in the vehicle body 12. The side door 20 is a door for a user to get in and out of the vehicle 10. The side door 20 is attached to the vehicle body 12 via a hinge (not shown) and is configured to be swingable in the horizontal direction. A window frame 22 is provided in the side door 20. The window frame 22 is placed in an upper part of the side door 20. Two sash bars 24, 26 (a first sash bar 24 and a second sash bar 26) are provided inside the window frame 22. The two sash bars 24, 26 are provided in parallel to each other and extend generally in the up-down direction. The window frame 22 and the two sash bars 24, 26 define three window openings 28a, 28b, 28c. Note that the position of the side door 20 may be on a left side surface of the vehicle body 12. The position of the side door 20 can be designed in accordance with regulations or the like of countries or districts.

The three window openings 28a, 28b, 28c include a first window opening 28a, a second window opening 28b, and a third window opening 28c. The first window opening 28a is placed most forward among the three window openings 28a, 28b, 28c and is surrounded by the window frame 22 and the first sash bar 24. First window glass 30 is provided in the first window opening 28a. The first window glass 30 is window glass provided in a fixed manner. The first window glass 30 is not openable and closable and is fixed to the window frame 22 and the first sash bar 24. The second window opening 28b is placed at an intermediate position and is surrounded by the window frame 22 and the two sash bars 24, 26. Second window glass 32 is provided in the second window opening 28b. The second window glass 32 is window glass that is openable and closable. The second window glass 32 is attached movably in the up-down direction between the two sash bars 24, 26. Third window glass 34 is provided in the third window opening 28c. The third window glass 34 is window glass provided in a fixed manner. The third window glass 34 is not openable and closable and is fixed to the window frame 22 and the second sash bar 26. Here, each window glass 30, 32, 34 is not limited to glass and may be constituted by other transparent or translucent materials such as acryl resin, for example.

The second window glass 32 is window glass configured to be manually raised and lowered. The window glass configured to be manually raised and lowered indicates window glass that is operated in the up-down direction directly by a user without the use of a mechanism such as a conventional raising-lowering device. When the window glass configured to be manually raised and lowered is employed, the conventional raising-lowering device can be omitted. Hereby, the internal structure of the side door 20 can be simplified, thereby making it possible to reduce the weight of the side door 20. Further, the second window glass 32 does not include a frame on its peripheral edge. When the second window glass 32 has a frameless structure as such, the second window glass 32 is reduced in weight, thereby making it possible to improve operationality for the user.

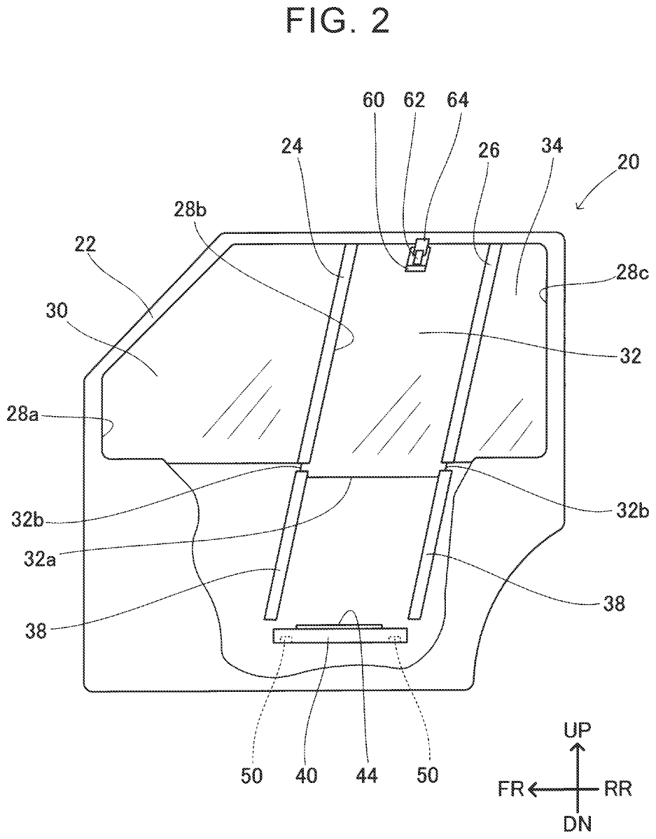

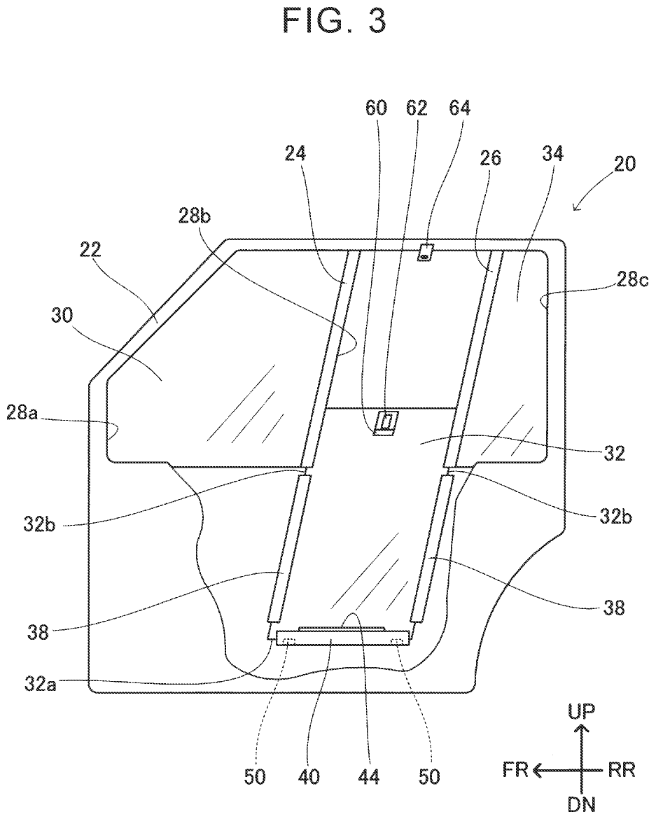

As illustrated in FIGS. 2, 3, the second window glass 32 is operated directly by the user to move in the up-down direction between an upper limit position at which the second window glass 32 closes the second window opening 28b and a lower limit position at which the second window glass 32 opens the second window opening 28b. Side edges 32b of the second window glass 32 are slidably supported by the two sash bars 24, 26. Further, a pair of rails 38 is provided inside the side door 20. The rails 38 slidably support the side edges 32b of the second window glass 32. A knob 60 to be gripped by the user is provided in the second window glass 32. The knob 60 is attached to an inner surface of the second window glass 32, and the knob 60 projects from the inner surface of the second window glass 32. The user can easily operate the second window glass 32 by use of the knob 60. That is, the user can raise the second window glass 32 by gripping the knob 60 or can lower the second window glass 32 by gripping the knob 60.

The knob 60 is provided with a movable hook 62 to be operated by the user. Meanwhile, the window frame 22 is provided with a hook receiver 64 corresponding to the hook 62. When the second window glass 32 is placed at the upper limit position, the hook receiver 64 engages with the hook 62. Hereby, the second window glass 32 placed at the upper limit position is locked so that the second window glass 32 does not move down by deadweight, for example Here, the positions of the knob 60, the hook 62, and the hook receiver 64 are not limited in particular. For example, the knob 60 and the hook 62 may be provided at different positions. Alternatively, the hook 62 may be provided in the window frame 22 while the hook receiver 64 may be provided in the second window glass 32.

A lower support 40, a vibration isolation member 44, and two stop members 50 are provided inside the side door 20. The lower support 40 is an elongated member extending in the front-rear direction and made of a resin material. Note that the material to form the lower support 40 is not limited in particular. When the second window glass 32 is placed at the lower limit position, the lower support 40 receives a lower edge 32a of the second window glass 32. The vibration isolation member 44 is attached to the lower support 40. The vibration isolation member 44 is made of a material more flexible than the lower support 40 and is provided between the lower support 40 and the second window glass 32. Hereby, the second window glass 32 placed at the lower limit position is supported stably by the rails 38 and the lower support 40.

The two stop members 50 are attached to the lower support 40. The number of the stop members 50 is not limited to two. As one example, in the vehicle 10 of the present embodiment, the two stop members 50 are placed on the opposite sides of the vibration isolation member 44, respectively. The stop members 50 are made of a rubber material and have moderate flexibility. Note that the material to form the stop members 50 is not limited to the rubber material and may be other materials that are more flexible (that is, with a lower rigidity) than the second window glass 32. When the second window glass 32 is placed at the lower limit position, the stop members 50 abut with the lower edge 32a of the second window glass 32.

As described above, in the vehicle 10 of the present embodiment, the window glass configured to be manually raised and lowered (that is, the second window glass 32) is employed for the second window opening 28b provided in the side door 20. By employing the window glass configured to be manually raised and lowered, the internal structure of the side door 20 can be simplified, thereby making it possible to reduce the weight of the side door 20. In the meantime, it is necessary that the window glass configured to be manually raised and lowered have a relatively small size so that the window glass configured to be manually raised and lowered can be operated effortlessly by force of the user. However, a reduction in the size of the second window glass 32 leads to a reduction in the size of the second window opening 28b. Generally, the window opening provided in the side door 20 is requested to function as an escape route for the user in an emergency. In this regard, when the second window opening 28b is reduced in size, the second window opening 28b cannot be used as the escape route.

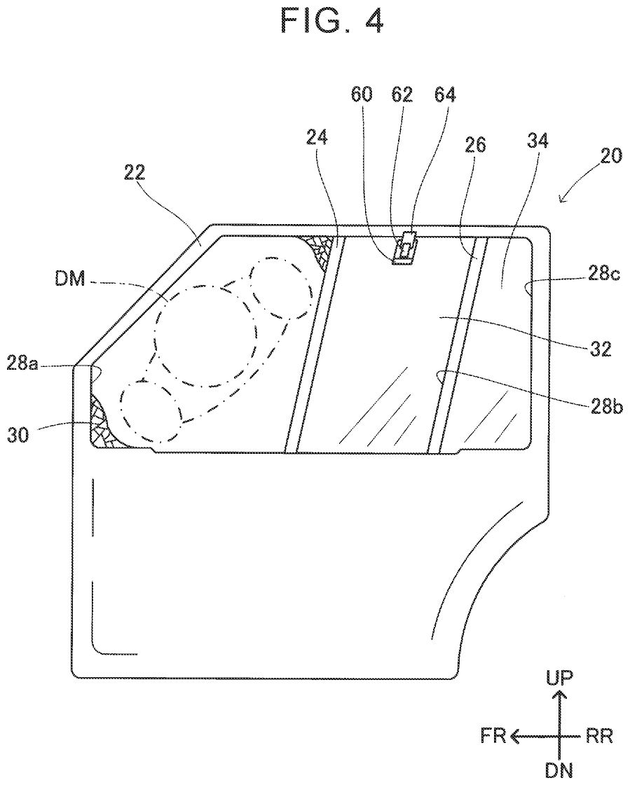

In consideration of this point, in the vehicle 10 of the present embodiment, the first window opening 28a has an area larger than that of the second window opening 28b. With such a configuration, as illustrated in FIG. 4, the first window opening 28a having a relatively large area can be set as an escape route for the user in an emergency. That is, in a case where an emergency event occurs, e.g., a case where the vehicle 10 is buried in water, for example, the user can escape to outside the vehicle 10 from the first window opening 28a by breaking the first window glass 30 provided in the first window opening 28a. For this purpose, it is necessary for the first window opening 28a to have a size and a shape that allow the user to go through the first window opening 28a. In this regard, in the vehicle 10 of the present embodiment, the size and the shape of the first window opening 28a are designed by use of a dummy doll DM for collision test as a reference. More specifically, the size and the shape of the first window opening 28a are designed so that the dummy doll DM as an adult male model can pass through the first window opening 28a.

Since the first window opening 28a is set as the escape route for the user, the area of the second window opening 28b can be designed to be small without any restriction. That is, it is not necessary for the second window opening 28b to have a size and a shape that allow the user to go through the second window opening 28b, that is, a size and a shape that allow the dummy doll DM as an adult male model to pass through the second window opening 28b. Hereby, by reducing the size of the second window glass 32 to be provided in the second window opening 28b, that is, by reducing the size of the window glass configured to be manually raised and lowered, the operationality for the user can be improved. Further, the first window opening 28a is placed ahead of the second window opening 28b and is placed generally diagonally forward of the user. In such a positional relationship, the user can easily break the first window glass 30 in an emergency, so that the first window opening 28a is easily usable as the escape route.

Particularly, in the vehicle 10 of the present embodiment, the first window opening 28a is placed most forward among the window openings 28a, 28b, 28c provided in the side door 20. In such a configuration, since the first window opening 28a is placed diagonally forward of the user, the user can easily break the first window glass 30 in an emergency. That is, the first window opening 28a is easily usable as the escape route. In addition, even at the time of normal driving, the user can easily visually recognize a diagonally front side from the vehicle 10 through the relatively large first window opening 28a.

In the vehicle 10 of the present embodiment, the side door 20 includes the third window opening 28c in addition to the first window opening 28a and the second window opening 28b. The third window opening 28c is placed rearward of the second window opening 28b in the vehicle front-rear direction and includes the third window glass 34 provided in a fixed manner. That is, in the side door 20 of the present embodiment, the first window opening 28a and the third window opening 28c are placed on the front side and the rear side of the second window opening 28b. With such a configuration, by adjusting the size and the shape of the third window opening 28c as well as the size and the shape of the first window opening 28a, the size and the shape of the second window opening 28b can be designed freely regardless of the shape of the side door 20. Hereby, the size and the shape of the second window glass 32 to be provided in the second window opening 28b, that is, the size and the shape of the window glass configured to be manually raised and lowered can be designed freely, thereby making it possible to effectively increase the operationality for the user.

In the vehicle 10 of the present embodiment, the third window opening 28c has an area smaller than that of the second window opening 28b. When the third window opening 28c is made small in a limited size of the side door 20, the first window opening 28a can be increased by just that much. This can improve the function of the first window opening 28a as the escape route.

The embodiment has been described above in detail, but the embodiment is only an example and does not limit the scope of Claims. The technology described in the scope of Claims includes the foregoing examples with various modifications and changes.

Each of and various combinations of the technical elements described in the present specification or the drawings achieve technical utility, and the technical elements are not limited to the combination stated in the claims at the time of filing. Further, the technology described in the present specification or the drawings can achieve a plurality of objects at the same time and has a technical usability by achieving one of those objects.

What is claimed is:

1. A vehicle comprising:
a vehicle body;
a side door provided openably and closably in the vehicle body, the side door including at least a first window opening and a second window opening;
first window glass provided in a fixed manner in the first window opening of the side door; and
second window glass configured to be manually raised and lowered, the second window glass being provided in the second window opening of the side door, wherein:
the first window opening is placed ahead of the second window opening in a vehicle front-rear direction; and
the first window opening has an area larger than an area of the second window opening.

2. The vehicle according to claim 1, wherein the first window opening has a size and a shape that allow a dummy doll as an adult male model to pass through the first window opening.

3. The vehicle according to claim 2, wherein the first window opening is placed most forward in the vehicle front-rear direction among the window openings provided in the side door.

4. The vehicle according to claim 1, wherein the second window glass does not include a frame on a peripheral edge of the second window glass.

5. The vehicle according to claim 1, wherein a knob to be gripped by a user is provided in the second window glass.

6. The vehicle according to claim 5, wherein:
the knob includes a movable hook to be operated by the user; and
the side door includes a hook receiver configured to lock the second window glass by engaging with the hook when the second window glass closes the second window opening.

7. The vehicle according to claim 1, wherein the side door further includes a third window opening placed rearward of the second window opening in the vehicle front-rear direction and including third window glass provided in a fixed manner.

8. The vehicle according to claim 7, wherein the third window opening has an area smaller than the area of the second window opening.
